(19) United States
(12) Patent Application Publication
(10) Pub. No.: US 2005/0276184 A1
(43) Pub. Date: Dec. 15, 2005

(54) Optical disk, optical disk device, and method for setting optical disk device

(75) Inventors: Ryutaro Futakuchi, Hirakata city (JP); Kenji Koishi, Sanda city (JP)

Correspondence Address: WENDEROTH, LIND & PONACK, L.L.P., 2033 K STREET N. W., SUITE 800, WASHINGTON, DC, 20006-1021, US

(73) Assignee: Matsushita Electric Industrial

(21) Appl. No.: 11/136,487

(22) Filed: May 25, 2005

(30) Foreign Application Priority Data
Jun. 14, 2004 (JP) 2004-175131

(51) Int. Cl. G11B 7/00

(52) U.S. Cl. 369/47.1; 369/53.2

(57) ABSTRACT

An optical disk, an optical disk device, and a method for setting an optical disk device are disclosed, in which the optical disk can enter a good state of recording and reproduction within a shorter amount of time. Specific information including parameters that determine the recording and reproduction state of an optical disk are prerecorded on said optical disk. An optical disk device decides the characteristics of a control circuit for recording and reproduction to and from an optical disk, on the basis of the recorded specific information.

### BACKGROUND OF THE INVENTION

1. Field of the Invention

The present invention relates to an optical disk, an optical disk device, and a method for setting an optical disk device, and more particularly relates to an optical disk, an optical disk device, and a method for setting an optical disk device, with which it is possible to perform recording and reproduction suited to the specific characteristics of an optical disk.

2. Background Information

One way to achieve a good recording and reproduction state of an optical disk is to install a so-called learning function in an optical disk device. In general, in the learning process, the characteristics of the circuits that make up the optical disk device are successively varied while monitoring a specific signal that serves as an index of the recording and reproduction state of the optical disk. Further, the characteristics of the circuits that make up the optical disk device are fixed by determining whether or not the state of the signal being monitored is within a specified permissible range.

For instance, Japanese Laid-Open Patent Application H11-7638 discusses a method for optimizing the characteristics of a focus servo and continuing this state on the basis of a standard method for relaying the above-mentioned learning function. Japanese Laid-Open Patent Application H6-301996 discusses a learning method that deals with a tracking servo in addition to the optimization of the characteristics of the focus servo.

FIG. 6 is a diagram of the basic constitution of a focus servo involving a learning function in an optical disk device. FIG. 6 is given for the purpose of highlighting the problems which the invention is intended to solve and illustrating the gist of a standard learning function.

In FIG. 6, 100 is an optical disk, and 101 is an optical head. The optical head 101 is made up of a light source (laser) that emits a laser beam for recording and reproducing data, a specific optical system for controlling the laser beam, an actuator for supporting and driving an objective lens, and a photodetector for synthesizing a tracking error signal, a focus error signal, and a reproduction RF signal from light reflected from the optical disk 100. 102 is the above-mentioned focus error signal, which is outputted according to a specific detection method.

The constituent elements of the optical head 101 will not be described in detail.

The focus error signal 102 is inputted to the negative input of a differential amplifier 103, and subjected to differential amplification with a reference voltage 121 inputted to the positive input. The gain thereof is set externally, that is, from a CPU 110, as a gain setting 111. This setting procedure is itself a learning function. This will be described in detail below.

The output of the differential amplifier 103 is inputted to a phase compensation circuit 104 via a loop switch 120, where it is subjected as needed to phase lag and phase lead compensation, and then outputted as a focus control signal 105. The focus control signal 105 is amplified in power by a power amplifier 106, and the output signal 107 thereof is sent to an actuator for supporting and driving an objective lens installed in the optical head 101. The above constitutes a focus servo.

The loop switch 120 is used to switch the focus servo on and off. This on/off control is performed by the CPU 110, which activates an on/off command signal 122, but the above description assumes an “on” state.

Whether the state of the focus servo is good or bad is determined by how well the vertical runout of the optical disk 100 can be tracked. This determination is generally performed by using the magnitude of oscillation of the fundamental frequency component of the focus control signal 105 (the number of rotations per second of the optical disk 100). This oscillation level expresses in relative terms the distance between the recording and reproduction surface of the optical disk 100 and the focal point position of the objective lens installed in the optical head 101. Accordingly, the lower is the oscillation level of the focus control signal 105, the better is the tracking ability and the better is the state of the focus servo.

In other words, to further improve the tracking capability of the focus servo, the loop gain of the focus servo should be raised as high as possible; for instance, the gain setting 111 to the differential amplifier 103 may be reset in the direction in which the gain of the differential amplifier 103 rises.

Therefore, to combine the above descriptions, the learning function according to a focus servo constituted as shown in FIG. 6 is such that the loop gain of the focus servo is varied while monitoring the oscillation level of the focus control signal 105, that is, the gain setting 111 of the differential amplifier 103 is suitably varied and the gain setting 111 of the differential amplifier differential amplifier 103 is fixed at the point when the oscillation level of the focus control signal 105 is within a specific permissible range. The specific constitution is such that the focus control signal 105 is suitably subjected to filtering with a filter 108, the level of this signal is digitized by an A/D converter 109, and then the output data value of the A/D converter 109 (which corresponds to the level of the focus control signal 105) is successively evaluated by the CPU 110 while the output data thereof, that is, the gain setting 111 to the differential amplifier 103, is either varied or fixed.

FIG. 7 is a flowchart that helps to illustrate the above description. Referring to FIG. 7, in step 130 an initial value A0 is set as the gain A of the differential amplifier 103 in FIG. 6. Next, in step 131 the focus servo is switched on. In step 132 the level of the focus control signal 105 is evaluated. If the level is outside the permissible range, the flow proceeds to step 133, where the gain of the differential amplifier 103 is varied by a tiny amount DA and set, and the level of the focus control signal is again evaluated in step 132. Therefore, the processing of varying the gain of the differential amplifier 103 by a tiny amount DA and setting this gain based on the evaluation of the level of the focus control signal 105 in step 132 is executed until the result of evaluating the oscillation level of the focus control signal 105 in step 132 falls within the specific permissible range.

On the other hand, if the result of evaluating the oscillation level of the focus control signal 105 in step 132 is within the specific permissible range, the gain of the differential amplifier 103 is fixed in step 134 and learning is concluded (135 in FIG. 7).

Under the evaluation conditions in step 132 of FIG. 7, the oscillation level of the focus control signal 105 is used as a threshold value. This threshold value is one that ensures the reliability of the recording and reproduction of data to and from the optical disk 100, and can be found by reverse calculation of the permissible distance between the recording and reproduction surface of the optical disk 100 and the focal point position of the objective lens installed in the optical head 101.

A typical learning function was summarized above by using a focus servo involving a learning function as an example. However, as today's optical disks and optical disk devices attain ever higher density and data transfer rates, the performance specifications required of the various circuits that make up optical disk devices are becoming extremely stringent. Therefore, how well data reliability can be ensured in the reproduction of recorded data by a reproduction operation is a key to developing comprehensive optical disk systems including media.

Therefore, the introduction of a learning function for achieving better recording and reproduction with an optical disk is not limited to the focus servo discussed above or a tracking servo with which a similar learning function can be achieved, but tends to have a very wide range, including the optimization of the characteristics of a reproduction processing circuit, optimization of recording power characteristics, optimization of recording compensation characteristics for keeping the duty of a reproduction signal consistent, and so forth.

Expansion of the learning function as discussed above does ensure reliability as mentioned, but the downside is that it takes a longer time for the execution of the learning function to be concluded over all ranges. In particular, if the execution of the learning function is concentrated during the start-up of the optical disk, there will be a long wait time from the commencement of start-up until the disk is in a state in which recording and reproduction are actually possible, and a longer wait time is clearly undesirable.

In view of this, it is an object of the present invention to provide an optical disk, an optical disk device, and a method for setting an optical disk device, with which the optical disk can enter a good state of recording and reproduction within a shorter time.

### SUMMARY OF THE INVENTION

In order to solve the above problems encountered in the past, the optical disk of the present invention has a specific information storage region in which information related to characteristics specific to that optical disk is recorded ahead of time. Also, this specific information includes at least one type of information selected from among the reflectance of the recording and reproduction surface, the vertical acceleration, and the eccentric acceleration. This information includes information defined for each data transfer rate of the optical disk.

The specific information storage region referred to here may be a region that in which the reproduction of information recorded in pit form (such as a control track region) is possible, or may be a region in which the recording and/or reproduction of data on the optical disk is possible.

The optical disk device of the present invention comprises parameter acquisition means and control circuit setting means. The parameter acquisition means acquires the parameters by performing reproduction processing of the specific information storage region of the optical disk. The control circuit setting means sets a control circuit used for recording or reproduction, on the basis of the parameters acquired by the parameter acquisition means. The control circuit setting means, for example, suitably converts the acquired parameters and thereby produces a setting that determines the characteristics of the control circuit.

The optical disk device of the present invention reads information related to characteristics specific to the optical disk of the present invention from this optical disk, and suitably converts the read information, thereby producing a setting for determining the characteristics of the control circuit that makes up this optical disk device, and uses this setting as the initial value at the start of learning for obtaining the optimal recording and reproduction state.

As long as the optical disk has not been ejected from the optical disk device, the optical disk device of the present invention maintains the result of executing the learning function as the setting for determining the characteristics of the control circuit that makes up this optical disk device.

In addition, as long as the optical disk has not been ejected from the optical disk device, the optical disk device of the present invention employs the result of executing the learning function as the initial value for executing the next learning function, and sets this to the control circuit that makes up the optical disk device.

A method for setting an optical disk device of the present invention comprises a parameter acquisition step and a control circuit setting step. The parameter acquisition step involves acquiring the parameters by performing reproduction processing of the specific information storage region of the optical disk. The control circuit setting step involves setting a control circuit used for recording or reproduction, on the basis of the parameters acquired in the parameter acquisition step.

The optical disk, optical disk device, and setting method of the present invention make it possible to perform recording or reproduction by utilizing characteristics specific to this optical disk. Specifically, it is possible to bring the optical disk into a good recording and reproduction state in a shorter time during start-up, for example.

In addition, in the execution of a learning function for further improving the recording and reproduction state, it is possible to utilize the characteristics specific to the optical disk as the initial value at the start of learning. Specifically, it is possible to shorten the time it takes for learning processing performed at start-up, for example.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a block diagram of the optical disk device in Embodiment 1 of the present invention;

FIG. 2 is a block diagram of the optical disk device in Embodiment 2 of the present invention;

FIG. 3 is a flowchart of the learning performed in the optical disk device in Embodiment 2 of the present invention;

FIG. 4 is a flowchart of the learning performed in the optical disk device in a modification of Embodiment 2 of the present invention;

FIG. 5 is a flowchart of the learning performed in the optical disk device in a modification of Embodiment 2 of the present invention;

FIG. 6 is a block diagram of the optical disk device in a conventional example; and

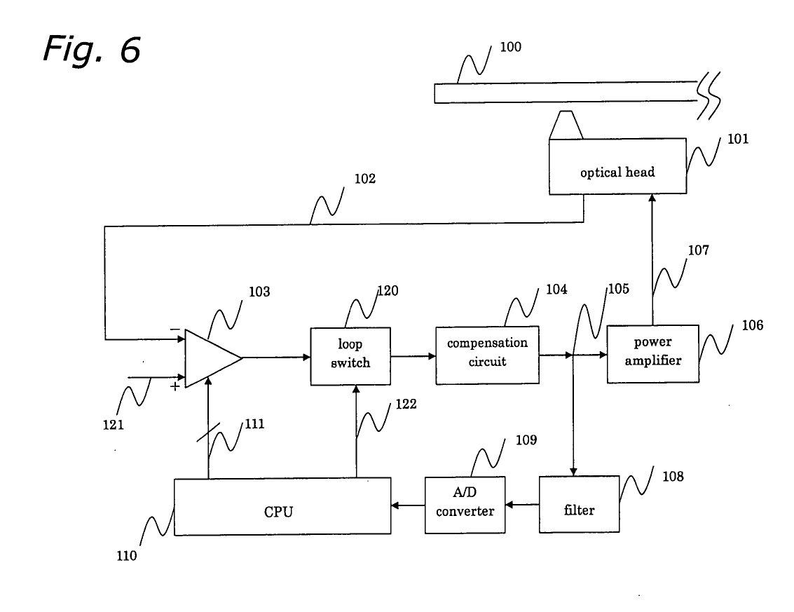

FIG. 7 is a flowchart of the learning performed in the optical disk device in a conventional example.

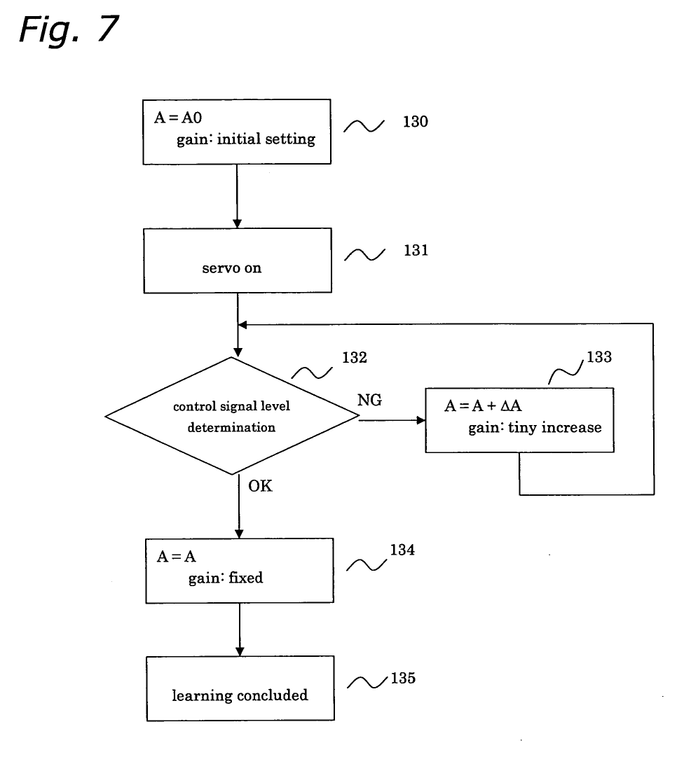

### DETAILED DESCRIPTION OF THE PREFERRED EMBODIMENTS

Embodiments of the present invention will now be described through reference to the drawings.

### Embodiment 1

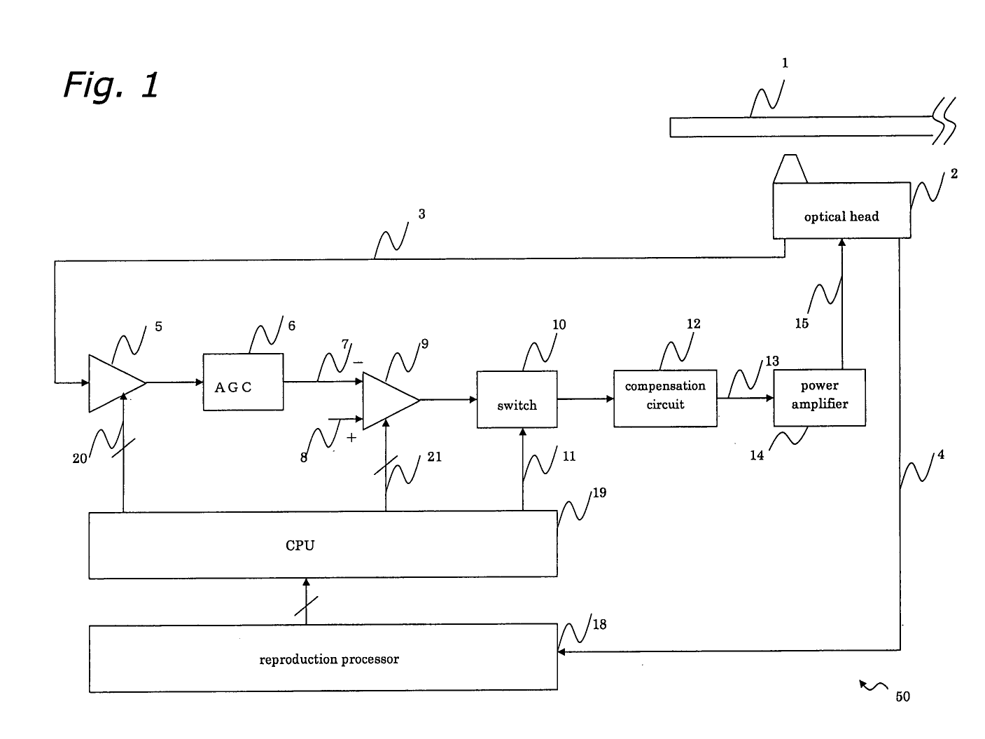

FIG. 1 is a diagram of the constitution of an optical disk device 50 in Embodiment 1 of the present invention, and more particularly is a diagram of the constitution of a focus servo or tracking servo. An optical disk 1 is the optical disk of the present invention. The optical disk 1 in the present invention is characterized in that parameters related to the characteristics of the recording and reproduction state of the optical disk 1 are prerecorded in a specific region, such as a control track region defined by any of various disk standards, as specific information about the optical disk 1. The specific region is not limited to this, however, and may be either a region in which only the reproduction of information recorded in pit form is possible, or a region in which the recording or reproduction on the optical disk is possible.

A focus servo or tracking servo is used as an example in the description of this embodiment. Therefore, the parameters that determine the recording and reproduction state of the optical disk will be described as the reflectance of the recording and reproduction surface of the optical disk and the vertical acceleration or the eccentric acceleration.

With a typical optical disk device, there is no major difference in the basic structure of the focus servo and the tracking servo, so in this embodiment both the focus servo and the tracking servo will be described through reference to the same drawing (FIG. 1).

To continue the description of FIG. 1, 2 is an optical head, which is made up of a light source (laser) that emits a laser beam for recording and reproducing data, a specific optical system for controlling the laser beam, an actuator for supporting and driving an objective lens, and a synthesizing means (such as a photodetector) for synthesizing a focus error signal 3 (or a tracking error signal 3) and a reproduction RF signal 4 from light reflected from the optical disk 1.

As discussed above, the focus error signal 3 (or tracking error signal 3) outputted from the optical head 2 is inputted to an amplifier 5. The output signal from the amplifier 5 is inputted to an AGC 6. The AGC 6 is provided for the purpose of keeping the focus error signal 3 (or tracking error signal 3), which can fluctuate due to a number of factors, at a consistent level. Some of these various factors include variance of the reflectance from optical disk to optical disk (the object of recording and reproduction), and power fluctuation in the laser beam used for the recording and reproduction of data.

The amplifier 5 is provided for the purpose of adjusting the input level of the AGC 6 so that it will be roughly in the middle of the input range.

The gain of the amplifier 5 is set by an externally provided CPU 19 as a first gain setting 20, which is the result of a specific calculation. How this first gain setting 20 is arrived at will be described below.

The output signal 7 of the AGC 6 is inputted to the negative input of a differential amplifier 9, and subjected to differential amplification with a reference voltage 8 inputted to the positive input. The output signal of the differential amplifier 9 is inputted to a phase compensation circuit 12 via a loop switch 10 (which is opened and closed by an on/off command 11 whose state is determined by the CPU 19), where it is subjected as needed to phase lag and phase lead compensation, and then outputted as a focus control signal 13 (or tracking control signal 13). The outputted focus control signal 13 (or tracking control signal 13) is amplified in power by a power amplifier 14, and outputted as an output signal 15. The output signal 15 is sent to an actuator for supporting and driving an objective lens installed in the optical head 2. The above constitutes a focus servo (or tracking servo) if the loop switch 10 is “on.”

The gain of the differential amplifier 9 is set by the externally provided CPU 19 as a second gain setting 21, which is the result of a specific calculation. How this second gain setting 21 is arrived at will be described below.

How the first gain setting 20 of the amplifier 5 (provided for the purpose of adjusting the input level of the AGC 6 so that it will be roughly in the middle of the input range) and the second gain setting 21 of the differential amplifier 9 are arrived at will now be described.

First, let us describe how we arrive at the first gain setting 20 of the amplifier 5.

First of all, the CPU 19 assumes that the reflectance of the optical disk 1 is a specific reference value, and sets a first gain setting 20 that matches this reference value in the amplifier 5. Next, the reproduction RF signal 4 is sent to a reproduction processor 18 in order to reproduce specific information that has been prerecorded on the optical disk 1 (the optical disk of the present invention). More specifically, the optical head 2 reads specific information from a control track region in which specific information has been stored, and outputs the reproduction RF signal 4. The reproduction processor 18 subjects the reproduction RF signal 4 to specific processing, selects information that indicates the reflectance specific to the optical disk 1, and outputs this to the CPU 19. The CPU 19 acquires information that indicates the reflectance specific to the optical disk 1, calculates, on the basis of this information, the gain of the amplifier 5 such that the level of the input signal of the AGC 6 shown in FIG. 1, that is, the level of the output signal from the amplifier 5, will be in the middle of the input range of the AGC 6, and sets this as the first gain setting 20 in the amplifier 5. This calculation of gain may be accomplished by having the CPU 19 refer to a table listing the relationships between gain and reflectance, which is stored in a ROM or other such memory device (not shown).

Therefore, as discussed above, the input level of the AGC 6 can be put in the middle of the input range on the basis of the reflectance of each optical disk that is the object of recording and reproduction. Specifically, this means that any variance in the individual reflectance between optical disks that are the object of recording and reproduction can be absorbed. Accordingly, the capability of the AGC 6 can be devoted to the absorption of variance caused by factors arising only in the optical disk device, such as fluctuation of laser power, which affords more stable recording and reproduction operation.

We will now describe how we arrive at the second gain setting 21 of the differential amplifier 9.

First, the CPU 19 assumes that the vertical acceleration (or eccentric acceleration) of the optical disk 1 is a specific reference value with respect to the data transfer rate employed in this embodiment (which depends on the rotational speed of the optical disk 1), and sets a second gain setting 21 that matches this reference value (the loop gain of the servo needed to obtain adequate tracking capability with respect to the vertical acceleration (or eccentric acceleration)) to the differential amplifier 9. The second gain setting 21 set here has been calculated in advance. Next, the reproduction RF signal 4 is sent to the reproduction processor 18 in order to reproduce specific information that has been prerecorded on the optical disk 1 (the optical disk of the present invention). More specifically, the optical head 2 reads specific information from a control track region in which specific information has been stored, and outputs the reproduction RF signal 4. The reproduction processor 18 subjects the reproduction RF signal 4 to specific processing, selects information that indicates the vertical acceleration (or eccentric acceleration) of the optical disk 1, and sends this to the CPU 19.

The vertical acceleration (or eccentric acceleration) specific to the optical disk 1 and sent to the CPU 19 is defined ahead of time for each data transfer rate. Therefore, the vertical acceleration (or eccentric acceleration) selected by the reproduction processor 18 is the vertical acceleration (or eccentric acceleration) corresponding to the data transfer rate employed in this embodiment (which depends on the rotational speed of the optical disk 1).

The CPU 19 acquires the specific vertical acceleration (or eccentric acceleration) corresponding to the data transfer rate of the optical disk 1, calculates the second gain setting 21, which is the loop gain of the servo needed to obtain adequate tracking capability, on the basis of this information, and sets this result in the differential amplifier 9. For instance, this gain may be calculated by having the CPU 19 refer to a table listing the relationships between gain and vertical acceleration (or eccentric acceleration), which is stored in a ROM or other such memory device (not shown).

The method for calculating the loop gain of the servo needed to obtain adequate tracking capability on the basis of the vertical acceleration (or eccentric acceleration) is common knowledge, and will not be described in detail herein. Also, it should go without saying that this calculation method may be pre-programmed into the CPU 19.

Therefore, as discussed above, it is possible to determine the loop gain of the focus servo (or tracking servo) based on the vertical acceleration (or eccentric acceleration) for every optical disk that is the object of recording and reproduction, and furthermore according to the required data transfer rate. Specifically, it is possible to perform recording and reproduction while taking into account the specific characteristics for each optical disk that is the object of recording and reproduction, and the required data transfer rate. It is also possible to greatly reduce the time it takes until recording and reproduction are performed, that is, the setting time for each gain value.

The reason for defining the specific vertical acceleration (or eccentric acceleration) of the optical disk 1 for each desired data transfer rate is as follows. An increase in the data transfer rate (that is, an increase in the rotational speed of the optical disk 1) translates into an increase in the vertical acceleration (or eccentric acceleration). Consequently, for the optimal recording and reproduction state to be maintained regardless of the data transfer rate, a suitable gain must be set with respect to the differential amplifier 9 corresponding to each different data transfer rate, and the loop state of the focus servo (or tracking servo) optimized.

The specific information have a plurality of values of the vertical acceleration (or eccentric acceleration), which are set for the standard data transfer rate (1× speed) specific to the optical disk 1, and for 2× speed, 4× speed, 8× speed, 16× speed, and so on. If we let the vertical acceleration at 1× speed be 10 m/s2 in recording, then the vertical acceleration at 2× speed is 20 m/s2, and the gain setting to the differential amplifier 9 during 2× speed is double that during standard speed.

In the above description, the specific information was taken to be reflectance and vertical acceleration (or eccentric acceleration), but the specific information may include any one of these three, or may include all three.

### Embodiment 2

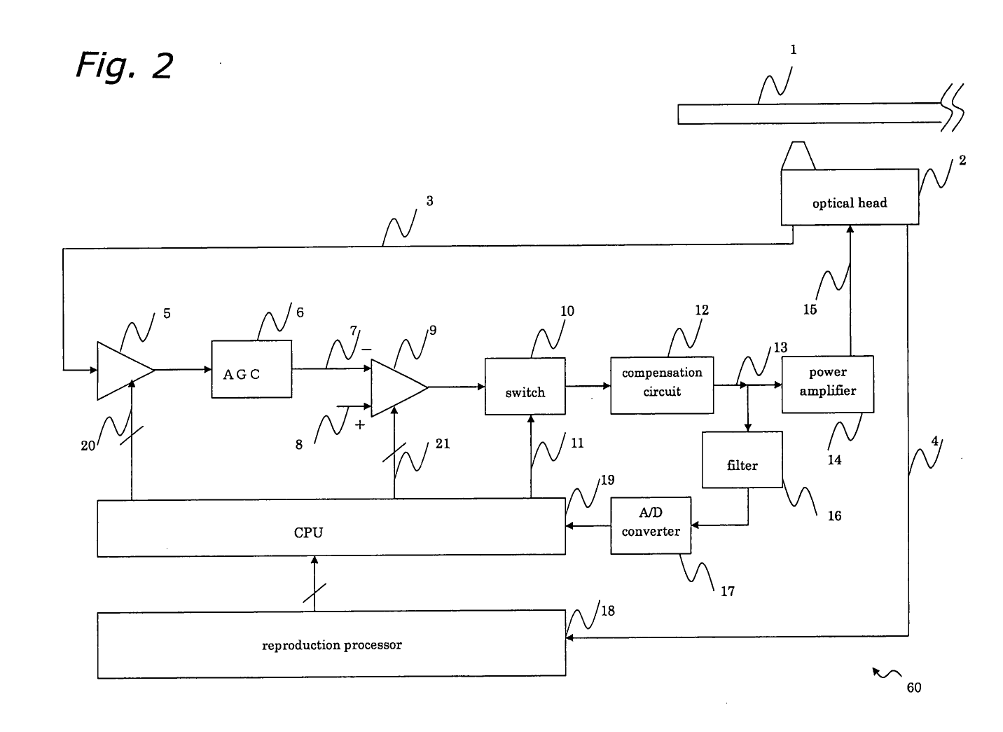

FIG. 2 is a diagram of the constitution of an optical disk device 60 in Embodiment 2 of the present invention. The optical disk device 60 shown in FIG. 2 shares most of its constituent elements with those in Embodiment 1 (see FIG. 1). Therefore, any common constituent elements are numbered the same as in FIG. 1, and those constituent elements that are the same as in Embodiment 1 will not be described again.

The optical disk 1 in FIG. 2 is also the optical disk of the present invention, just as in Embodiment 1, and the vertical acceleration (or eccentric acceleration) serving as the information specific to this disk is defined for every data transfer rate.

As seen in FIG. 2, in this embodiment, the focus control signal 13 (or tracking control signal 13) goes through a filter 16 and is digitized by an A/D converter 17, and is then inputted to the CPU 19. The CPU 19 optimizes the recording and reproduction state of the optical disk 1 while monitoring the state of this digitized focus control signal 13 (or tracking control signal 13) and while successively setting the gain of the differential amplifier 9. The provision of the above learning function is where this embodiment differs from Embodiment 1.

The learning function in this embodiment is characterized in that the CPU 19 calculates the gain setting 21 of the differential amplifier 9 on the basis of the vertical acceleration (or eccentric acceleration), which is information specific to the optical disk 1 that has been prerecorded to this optical disk 1, and furthermore is information corresponding to the data transfer rate required in this embodiment, and this gain setting is used as the initial value in the execution of this learning function.

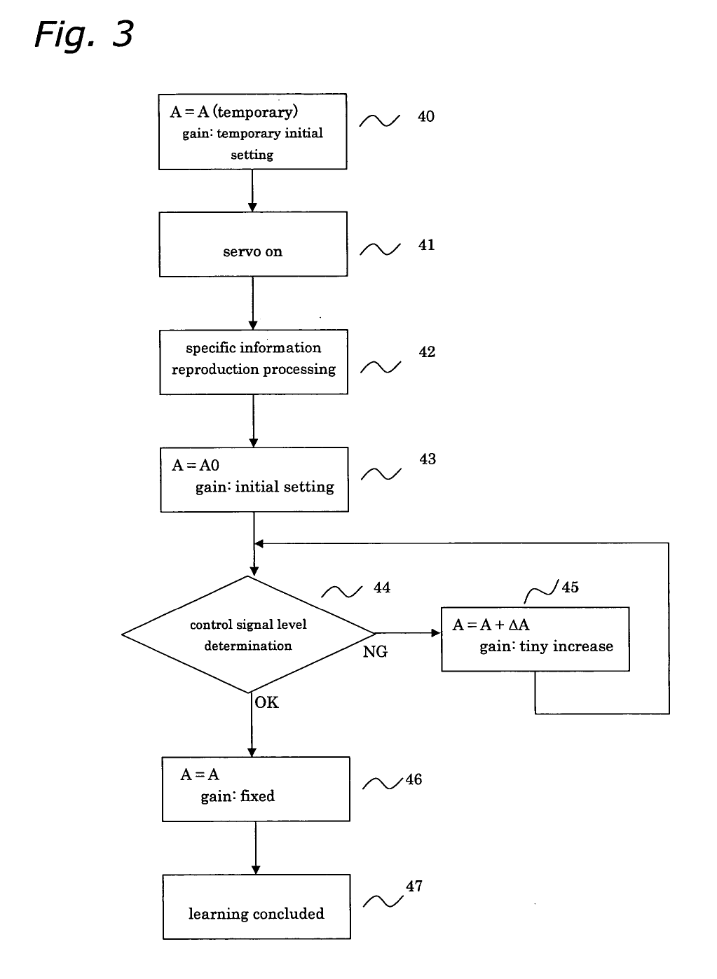

The above learning function will be discussed through reference to the flowchart in FIG. 3.

First, in step 40, the CPU 19 shown in FIG. 2 assumes that the vertical acceleration (or eccentric acceleration) of the optical disk 1 is a specific reference value corresponding to the data transfer rate required in this embodiment, using the second gain setting 21 matching this reference value (the loop gain of the servo needed to obtain adequate tracking capability with respect to the vertical acceleration (or eccentric acceleration)) as a temporary initial value, and sets this to the differential amplifier 9. The second gain setting 21 set here has been calculated in advance.

Next, in step 41, the operation of the CPU 19 shown in FIG. 2 activates the on/off command 11 of the loop switch 10, closes the loop switch 10, and switches on the servo loop.

Then in step 42 the optical head 2 and the reproduction processor 18 subject the specific information of the optical disk 1 (the vertical acceleration (or eccentric acceleration) corresponding to the data transfer rate) to reproduction processing.

In step 43, the CPU 19 acquires the specific vertical acceleration (or eccentric acceleration) of the optical disk 1 that has undergone this reproduction processing, calculates the second gain setting 21, which is the loop gain of the servo needed to obtain adequate tracking capability, on the basis of this information, and sets this result in the differential amplifier 9. The second gain setting 21 set here serves as the initial value in the execution of the learning function. The setting of the gain here is the same as described in Embodiment 1.

Then in step 44 the CPU 19 shown in FIG. 2 evaluates the oscillation level of the focus control signal 13 (or the tracking control signal 13), which is an indicator of whether the control state of the focus servo (or tracking servo) is good or bad. If the level is outside the permissible range, the flow proceeds to step 45, where the gain of the differential amplifier 9 is varied by a tiny amount DA and set, and the oscillation level of the focus control signal 13 (or the tracking control signal 13) is again evaluated in step 44.

Therefore, the processing of varying the gain of the differential amplifier 9 in step 45 by a tiny amount DA and setting this gain based on the evaluation of the oscillation level of the focus control signal 13 in step 44 is executed until the result of evaluating the oscillation level of the focus control signal 13 (or the tracking control signal 13) in step 44 falls within the permissible range.

On the other hand, if the result of evaluating the oscillation level of the focus control signal 13 (or the tracking control signal 13) in step 44 is within the permissible range, the gain of the differential amplifier 9 is fixed in step 46 and learning is concluded (47 in FIG. 3).

Under the evaluation conditions in step 44 of FIG. 3, the oscillation level of the focus control signal 13 (or the tracking control signal 13) is used as a threshold value. In the case of the focus control signal 13, this threshold value is one that ensures the reliability of the recording and reproduction of data to and from the optical disk 1, and can be found by reverse calculation of the permissible distance between the recording and reproduction surface of the optical disk 1 and the focal point position of the objective lens installed in the optical head 2.

Therefore, as discussed above, providing the learning function in this embodiment makes it possible to absorb variance in detection sensitivity and the like for the focus error signal 3 (or the tracking error signal 3) caused by factors other than the specific characteristics of the optical disk 1 that is the object of the recording and reproduction, that is, factors other than vertical acceleration (or eccentric acceleration), so the state of the focus servo (or tracking servo) can be further improved. Factors other than the specific characteristics of the optical disk 1 include the optical characteristics of the optical head 2, for example.

Furthermore, the initial value of the learning function is calculated on the basis of the vertical acceleration (or eccentric acceleration) corresponding to the data transfer rate of the optical disk 1 that is the object of recording and reproduction. This means that it is possible to shorten the time it takes for the learning results to reach their optimal state.

In addition, it is possible to preprogram the CPU 19 as follows in this embodiment. The CPU 19 keeps the gain of the differential amplifier 9 decided by the execution of the learning function in a storage device or the like (not shown) as long as the optical disk 1 is not ejected from the optical disk device 60.

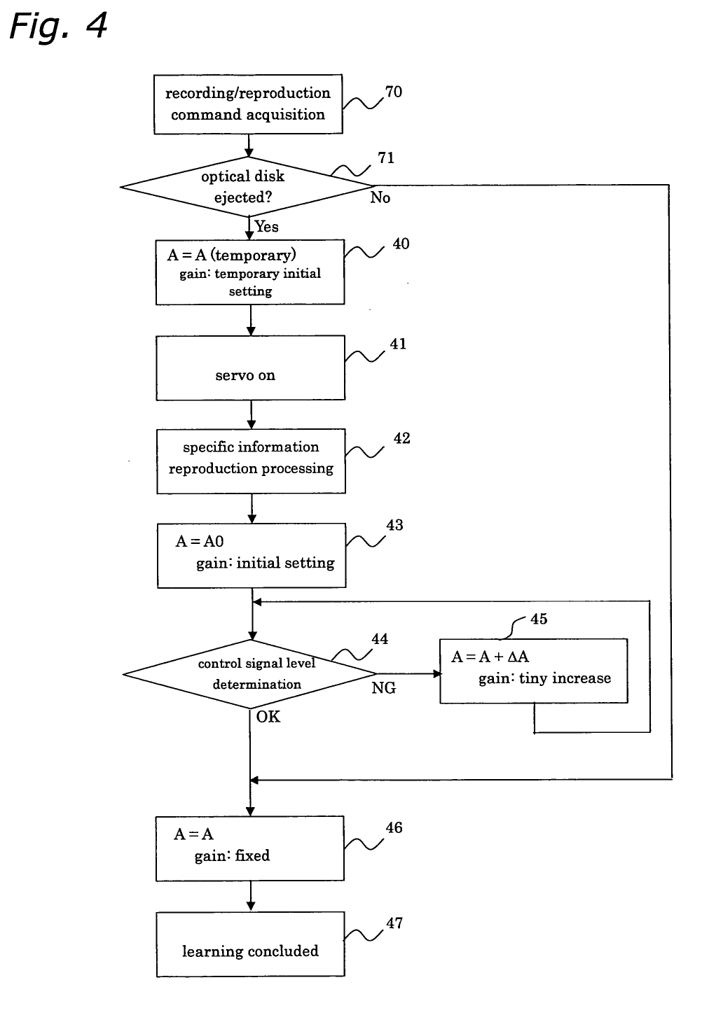

The specific processing here will be described through reference to FIG. 4. Any processing that is the same as in FIG. 3 numbered the same in FIG. 4, and will not be described again.

In step 70, a recording or reproduction command is acquired. Then, in step 71, it is determined whether or not the optical disk 1 was ejected from the optical disk device 60 after the execution of the learning function. The above processing is performed by a controller (not shown) that executes control of the optical disk device 60. This controller may be the same component as the CPU 19.

If the determination of step 71 is positive (the disk was ejected), the flow moves to step 40, in which the CPU 19 executes the learning function described through reference to FIG. 3.

On the other hand, if the determination in step 71 is negative (the disk was not ejected), the flow moves to step 46, in which the CPU 19 reads from a storage device or the like (not shown) the gain of the differential amplifier 9 decided by the execution of the learning function, sets this gain value in the differential amplifier 9, and concludes the learning function (step 47).

In this case, once the recording or reproduction operation has been concluded, it takes even less time until a stable recording and reproduction state is achieved during the next start-up.

Furthermore, in this embodiment, the CPU 19 can be programmed as follows. The CPU 19 keeps the gain of the differential amplifier 9 decided by the execution of the learning function in a storage device or the like (not shown) as long as the optical disk 1 is not ejected from the optical disk device 60. Further, the learning function is executed by using the gain held here as the initial value for the learning function at the next start-up.

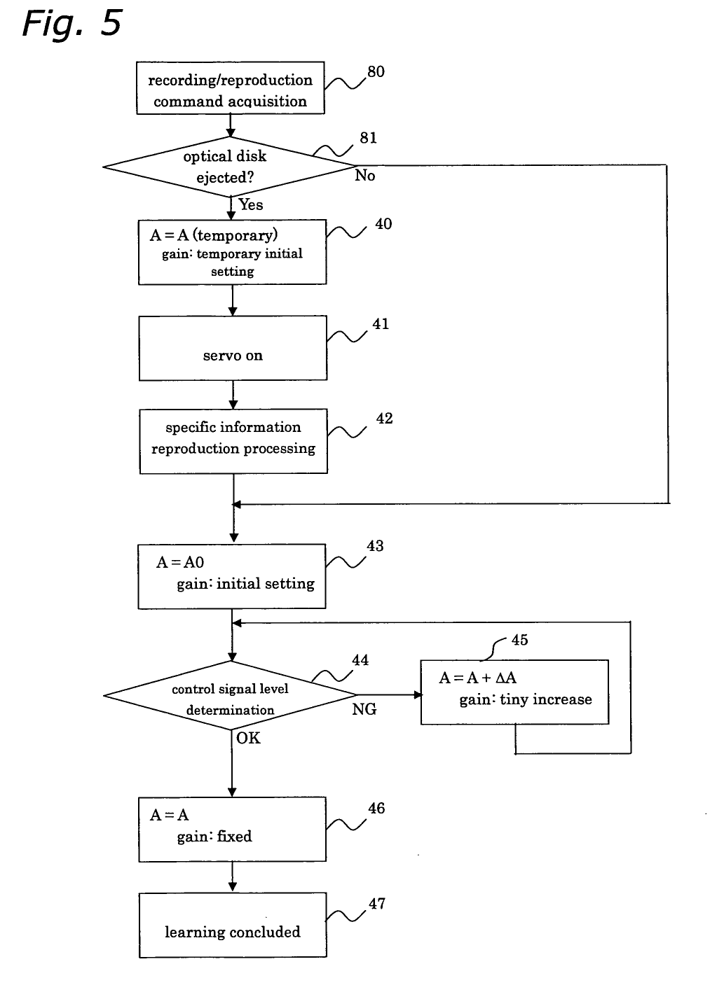

The specific processing will be described through reference to FIG. 5. In step 81, it is determined whether or not the optical disk 1 was ejected from the optical disk device 60 after the execution of the learning function. The above processing is performed by a controller (not shown) that executes control of the optical disk device 60. This controller may be the same component as the CPU 19.

If the determination of step 81 is positive (the disk was ejected), the flow moves to step 40, in which the CPU 19 executes the learning function described through reference to FIG. 3.

On the other hand, if the determination in step 81 is negative (the disk was not ejected), the flow moves to step 43, in which the CPU 19 reads from a storage device or the like (not shown) the gain of the differential amplifier 9 decided by the execution of the learning function, and sets this gain value in the differential amplifier 9 as the initial value of the learning function. The subsequent processing is the same as described through reference to FIG. 3.

In this case, an even more stable recording and reproduction state can be attained, and the time it takes to reach this state is also shorter.

The optical disk and optical disk device according to the present invention have the effect of achieving a state that is favorable in terms of absorbing variance in the specific characteristics of the optical disk that is the object of recording and reproduction so that recording and reproduction are possible, and shortening the time it takes to reach this state that is favorable for allowing recording and reproduction, and are therefore useful as optical disk drives, optical disk recorders, and the like, as well as information recording media thereof.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing description of the embodiments according to the present invention are provided for illustration only, and not for the purpose of limiting the invention as defined by the appended claims and their equivalents.

1. An optical disk for recording or reproducing data, comprising:
a specific information storage region in which specific information that is specific to the optical disk is stored in advance;
said specific information including one or more parameters for determining the recording and reproduction state of the optical disk.

2. The optical disk according to claim 1, wherein the one or more parameters are selected from the group consisting of the reflectance of the recording and reproduction surface, the vertical acceleration, and the eccentric acceleration.

3. The optical disk according to claim 2, wherein the vertical acceleration or the eccentric acceleration is determined according to the data transfer rate of the optical disk.

4. An optical disk device for recording or reproducing data to or from the optical disk according to claim 1, comprising:
a parameter acquisition unit operable to acquire the parameters by performing reproduction processing of the specific information storage region of the optical disk; and
a control circuit setting unit operable to set a control circuit used for recording or reproduction, on the basis of the parameters acquired by the parameter acquisition unit.

5. The optical disk device according to claim 4, wherein the parameters include the vertical acceleration; and
the control circuit setting unit sets a focus servo circuit on the basis of the vertical acceleration.

6. The optical disk device according to claim 5, wherein the parameters further include the reflectance of the recording and reproduction surface, and
the control circuit setting unit sets a gain adjustment circuit for adjusting the gain of a focus error signal inputted to the control circuit, on the basis of the reflectance.

7. The optical disk device according to claim 4, wherein the parameters include eccentric acceleration; and
the control circuit setting unit sets a tracking servo circuit on the basis of the eccentric acceleration.

8. The optical disk device according to claim 7, wherein the parameters further include the reflectance of the recording and reproduction surface; and
the control circuit setting unit sets a gain adjustment circuit for adjusting the gain of a tracking error signal inputted to the control circuit, on the basis of the reflectance.

9. The optical disk device according to claim 4, wherein the control circuit setting unit performs learning processing in which the recording and reproduction state is optimized while the setting of the control circuit is successively varied, and
the initial value of the learning processing is set on the basis of the parameters acquired by the parameter acquisition unit.

10. The optical disk device according to claim 9, wherein the control circuit setting unit sets the result of executing the learning processing to the control circuit until the optical disk is ejected.

11. The optical disk device according to claim 9, wherein the control circuit setting unit sets the result of executing the learning processing as the initial value for subsequent learning processing to the control circuit until the optical disk is ejected.

12. A method for setting an optical disk device for recording or reproducing data to or from the optical disk according to claim 1, comprising the steps of:
acquiring the parameters by performing reproduction processing of the specific information storage region of the optical disk; and
setting a control circuit used for recording or reproduction, on the basis of the parameters acquired in the parameter acquiring process.
